(19) United States
(12) Patent Application Publication
(10) Pub. No.: US 2019/0264633 A1
(43) Pub. Date: Aug. 29, 2019

(54) DUAL GALLERY TWO STROKE PISTON

(71) Applicant: Tenneco Inc., Lake Forest, IL (US)

(72) Inventor: Michael Weinenger, Southfield, MI (US)

(21) Appl. No.: 16/287,714

(22) Filed: Feb. 27, 2019

Related U.S. Application Data
(60) Provisional application No. 62/636,423, filed on Feb. 28, 2018.

(51) Int. Cl. F02F 3/00; B23K 9/02

(52) U.S. Cl. CPC F02F 3/003; B23K 9/02; B23K 2101/003; F02F 2200/00; F02F 2003/0061

(57) ABSTRACT

A piston assembly for a two-stroke internal combustion engine includes an upper part joined to a lower part by hybrid induction welding. The upper part includes an upper and lower walls radially spacing inner and outer walls to present an outer cooling gallery therebetween. The lower wall includes first portions extending radially inwardly from the outer wall to the inner wall above the skirt sections and second portions extending radially inwardly from the outer wall to the inner wall above the pin bosses. The first portions extend oblique to the center axis and undulate between the inner and outer walls to reduce the stiffness of the skirt sections. The second portions of the lower wall extend perpendicular to the center axis. Skirt sections of the piston include a lower portion with a greater radial thickness and containing ring grooves.

### CROSS-REFERENCE TO RELATED APPLICATIONS

This U.S. utility patent application claims priority to U.S. provisional patent application No. 62/636,423, filed Feb. 28, 2018, the entire content of which is incorporated herein by reference.

### BACKGROUND OF THE INVENTION

### 1. Field of the Invention

This invention relates to a piston for a two-stroke combustion engine, and a method of manufacturing the piston.

### 2. Related Art

In a two-stroke internal combustion engine which includes inlet and exhaust ports, rather than valves, a skirt of the piston is typically used to seal the combustion chamber. Ring grooves containing piston rings are typically present in the piston skirt to provide a proper seal to the combustion chamber and prevent gases from escaping from the combustion chamber. An example of a piston for a two-stroke engine is disclosed in U.S. Pat. No. 9,702,317.

### SUMMARY

One aspect of the invention provides a piston for a two-stroke internal combustion engine. The piston includes a body extending longitudinally along a center axis from an upper end to a lower end. The body includes an upper wall at the upper end, an outer wall and an inner wall each depending from the upper wall and extending circumferentially around the center axis, and a lower wall spaced axially from the upper wall by the outer and inner walls. The upper and lower walls radially space the inner wall from the outer wall and present an outer cooling gallery therebetween. A pair of skirt sections depend longitudinally from the outer wall, and a pair of pin bosses depend longitudinally from the outer wall and space the skirt sections from one another. The lower wall includes first portions extending radially inwardly from the outer wall to the inner wall above the skirt section, and the lower wall includes second portions extending radially inwardly from the outer wall to the inner wall above the pin bosses. The first portions extend oblique to the center axis, and the second portions extend perpendicular to the center axis. The skirt sections have a radial thickness which is greater in a lower portion of the skirt sections than an upper portion of the skirt sections, and the lower portion of the skirt sections include a plurality of ring grooves for containing piston rings.

Another aspect of the invention provides a method of manufacturing a piston comprising the steps of: providing an upper part extending along a center axis, the upper part including an upper wall, an upper outer rib depending from the upper wall, and an upper inner rib depending from the upper wall; and joining a lower part to the upper part. The lower part extends longitudinally along the center axis, the lower part includes a lower wall, a lower outer rib extends upward from the lower wall, a lower inner rib extends upward from the upper wall, skirt sections depend longitudinally from the lower wall, pin bosses depend longitudinally from the lower wall and space the skirt sections from one another, the lower wall includes first portions extending radially inwardly from the lower outer rib to the lower inner rib above the skirt sections, the lower wall includes second portions extending radially inwardly from the lower outer rib to the lower inner rib above the pin bosses, the first portions extend oblique to the center axis and the second portions extend perpendicular to the center axis, the skirt sections include a radial thickness being greater in a lower portion of the skirt sections than an upper portion of the skirt sections, and the lower portion of the skirt sections include a plurality of ring grooves for containing piston rings.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional side view of a two-stroke internal combustion engine including a piston according to an example embodiment;

FIG. 2 is a partially sectioned perspective view of a piston according to another example embodiment;

FIG. 3 is a cross-sectional side view taken along a pin bore axis of the piston of FIG. 2;

FIG. 4 is a cross-sectional top view of a lower part of the piston taken at 4-4 in FIG. 3;

FIG. 5 is a cross-sectional side view of a two-stroke internal combustion engine including a piston according to an example embodiment;

### DETAILED DESCRIPTION OF EXEMPLARY EMBODIMENTS

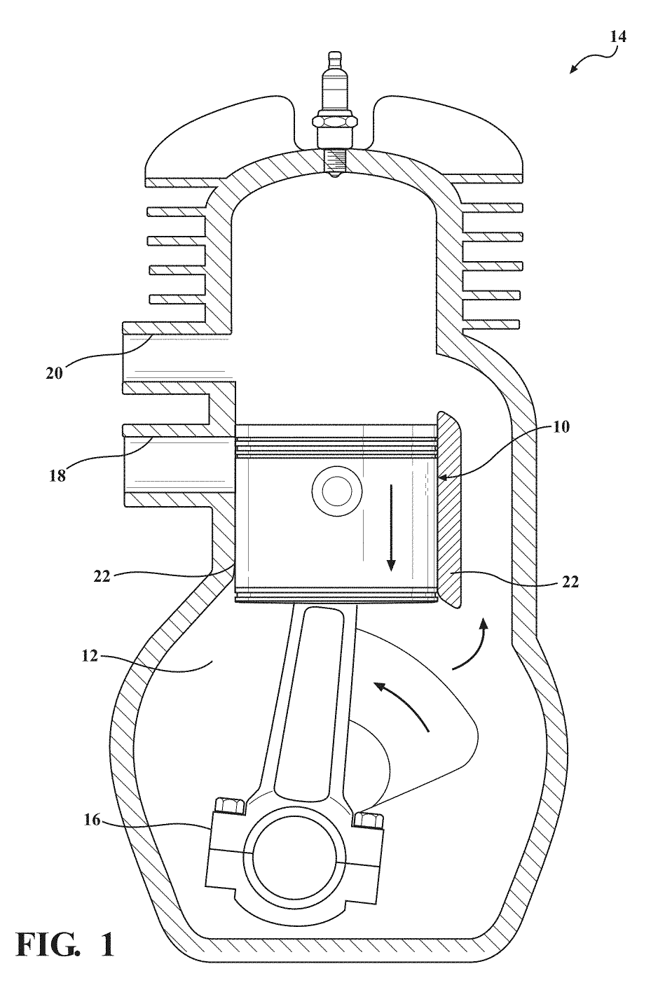

One aspect of the invention provides a piston 10 for reciprocating movement in a cylinder bore or chamber 12 of a two-stroke (or two-cycle) internal combustion engine 14, such as light vehicle diesel, mid-range diesel, heavy duty and large bore diesel engine, or gas engine. An example of the two-stroke internal combustion engine 14 including the piston 10 generally shown in FIG. 1. The two-stroke engine completes a power cycle with two strokes, e.g. up and down movements, of the piston 10 during only one crankshaft revolution. Typically, the two-stroke internal combustion engine 14 includes a crankcase 16 for gas exchange, an intake port 18, an exhaust port 20, and the piston 10. During operation of the two-stroke internal combustion engine 14, the piston 10 acts not only as a piston, but also as a compressor, an intake valve, and an exhaust valve. Because the two-stroke combustion engine 14 has the inlet and exhaust ports 18, 20, rather than valves, skirt sections 22 of the piston 10 are used to seal the combustion chamber 12 and used as intake and exhaust valves when the piston 10 reciprocates in the chamber 12.

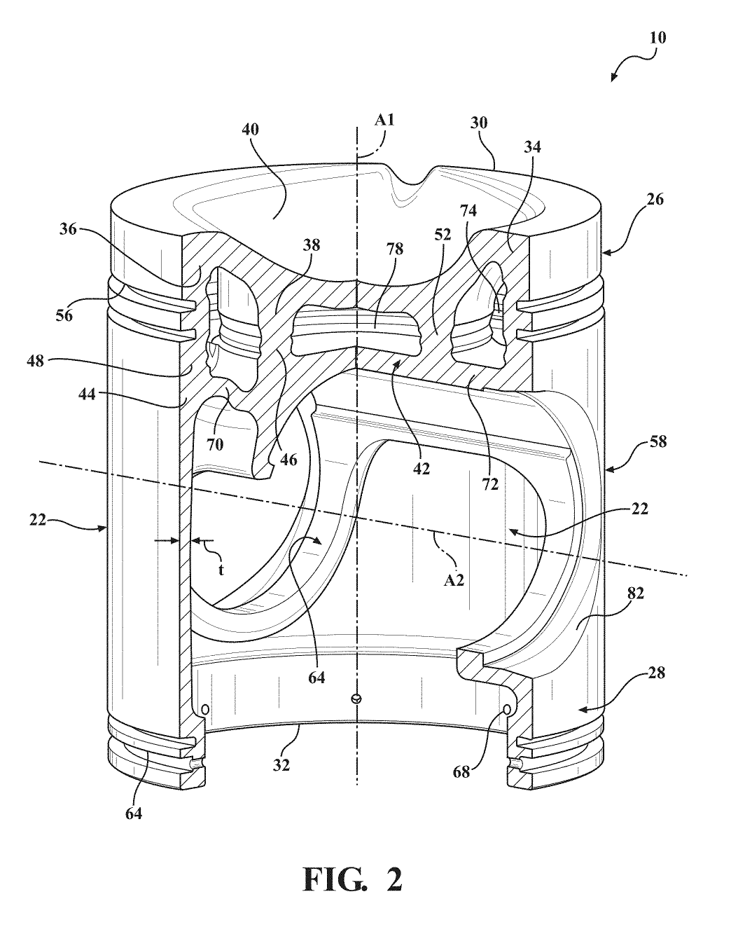

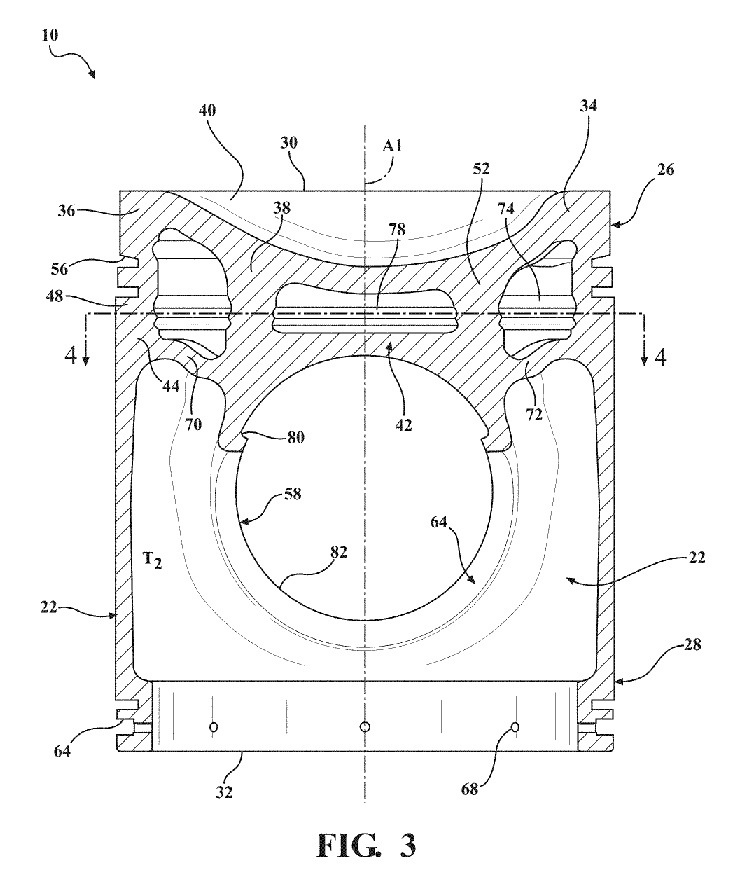

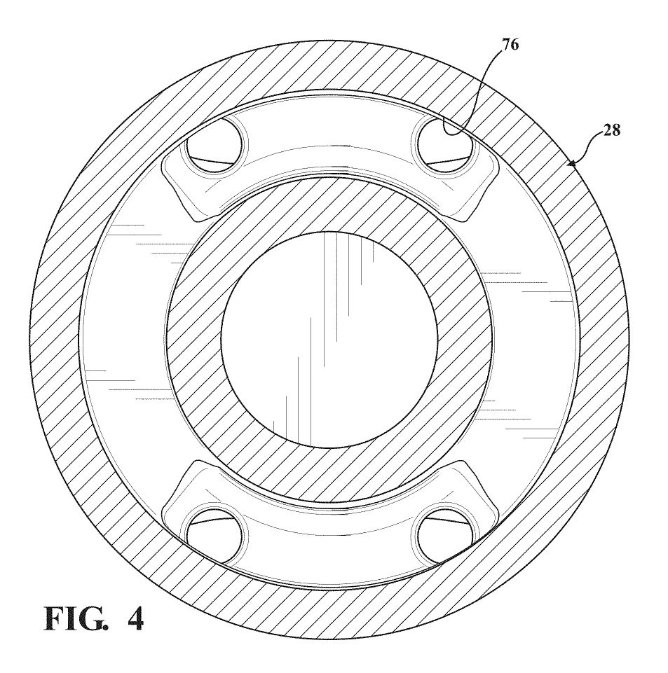

As shown in FIGS. 2-4, the piston 10 comprises a body including an upper part 26 joined to a lower part 28. The body has a generally cylindrical shape and extends longitudinally along a center axis A1 and from an upper end 30 to a lower end 32. The upper part includes an upper wall 34, an upper outer rib 36, and an upper inner rib 38. The upper wall includes a combustion surface 40 presenting a combustion bowl, and the combustion bowl has an asymmetric shape. The combustion bowl of the upper part 26 preferably has a design that is in an as-forged condition.

The lower part includes a lower wall 42, a lower outer rib 44, and a lower inner rib 46. The upper outer rib is joined to the lower outer rib at an outer joint 48 to form an outer wall, and the upper inner rib is joined to the lower inner rib at an inner joint 52 to form an inner wall. The outer wall and the inner wall extend circumferentially around the center axis. In the example embodiments, the inner and outer walls are parallel to the center axis, and the outer wall includes a plurality of upper ring grooves 56 for containing piston rings.

The body of the piston also includes a pair of the skirt sections 22 depending longitudinally from the outer wall, and a pair of pin bosses 58 depending longitudinally from the outer wall and spacing the skirt sections from one another. Each pin boss includes a pin bore 60. The skirt sections are connected to the pin bosses. The skirt sections have a radial thickness t which is greater in a lower portion of the skirt sections than an upper portion of the skirt sections. The lower portion of the skirt sections having the increased thickness includes a plurality of lower ring grooves 64 for containing piston rings. In the example embodiments, the lower portion of the skirt sections including the lower ring grooves is located axially below the pin bores. During use of the piston in an engine, the piston rings disposed in the lower ring grooves help to prevent gas from flowing past the skirt sections. The thickness of the skirt sections is lower above the lower ring grooves to increase flexibility of the skirt sections. The casting process is preferably used to form the skirt sections with the varying thickness along the length.

Also, the lower portion of the skirt sections can include apertures 68 for allowing cooling oil to flow through, as shown in the example embodiment. The skirt sections have convex outer surfaces contoured for sliding cooperation within the cylinder bore in a desired orientation as the piston reciprocates along the center axis through the cylinder bore.

The upper and lower parts are preferably joined by hybrid induction welding. However, another bonding process, such as induction welding, resistance welding, charge carrier rays, electron beam welding, laser welding, stir welding, brazing, soldering, hot or cold diffusion, friction welding, or another bonding process could be used to join the parts.

The upper and lower parts are typically formed of steel. According to one embodiment, the lower part is formed of 4140 steel, and the upper part is formed of a steel material different from the 4140 steel of the lower part. For example, the upper part can be formed of an alloy having a greater resistance to high temperatures than the 4140 steel of the lower part. Also, the lower part is typically produced by a steel casting process in order to incorporate geometry that may not be obtainable by forging.

The lower wall of the lower part includes first portions 70 extending radially inwardly from the outer wall to the inner wall above the skirt sections and second portions 72 extending radially inwardly from the outer wall to the inner wall above the pin bosses. The first portions extend oblique to the center axis, and the second portions extend perpendicular to the center axis. The first portions are spaced circumferentially from one another by the second portions. The first portions and the second portions also extend in an arcuate shape around the center axis.

As shown in the Figures, the lower wall is spaced axially from the upper wall by the outer and inner walls, and the upper and lower walls radially space the inner wall from the outer wall to present an outer cooling gallery 74 therebetween. The outer cooling gallery has an axial cross section which is asymmetric and is greater along the first portions of the lower wall than the second portions of the lower wall. The lower wall includes orifices 76 to the outer cooling gallery for allowing cooling oil to flow through. In the example embodiment, the orifices have a generally cylindrical shape. For example, the lower wall can include orifices providing an inlet to the outer cooling gallery and also orifices providing an outlet from the cooling gallery. Sealing members could also be disposed in the orifices to prevent the cooling medium from exiting the outer cooling gallery.

In the example embodiments, the first portions of the lower wall above the skirt sections present an angle of less than 90 degrees therebetween. Preferably, the first portions of the lower wall undulate between the outer wall and the inner wall. For example, the first portions can include waves between the outer and inner walls. The undulating or angled first portions of the lower wall provide for increased flexibility and reduced stiffness of the skirt sections at a top edge of the skirt sections adjacent the first portions, compared a horizontal lower wall. The first portions give in response to forces exerted on the top of the skirt sections, which enables the top of the skirt sections to be less rigid in the radial direction under compression loads, which ultimately reduces wear caused by the skirt sections engaging a cylinder liner.

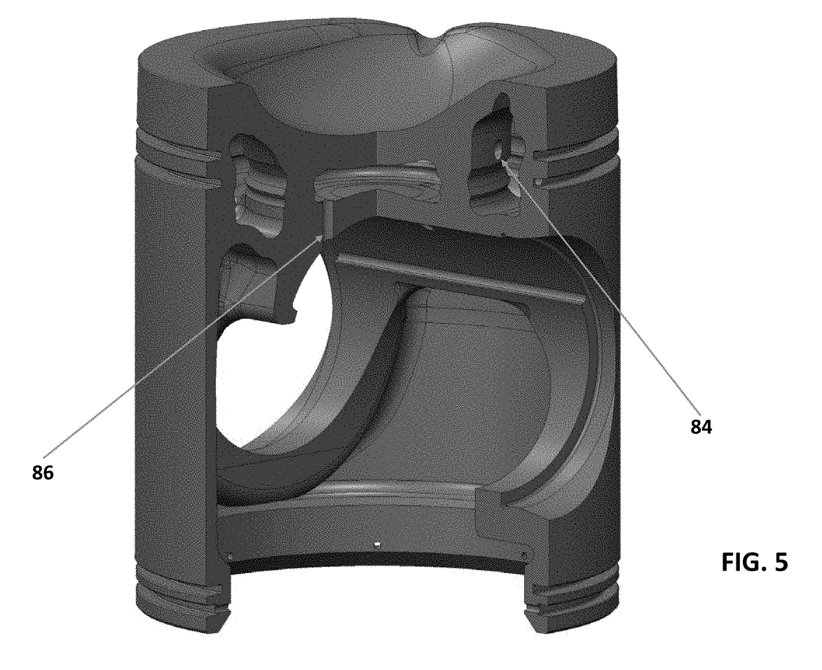

The body of the piston also includes an inner cooling gallery 78. The inner wall, the upper wall, and the lower wall present the inner cooling gallery therebetween. The inner cooling gallery also has an asymmetric shape. The inner cooling gallery is sealed and preferably contains air. However, the inner cooling gallery can contain coolants, such as but not limited to cooling oil. In the embodiment of FIG. 5, the inner wall of the body of the piston includes first holes 84 for communicating oil between the inner cooling gallery and the outer cooling gallery, as well as second holes 86 in the lower wall for communicating oil between the inner cooling gallery and a pin joint area located along the pin bores. The designs of the inner cooling gallery and the outer cooling gallery are primarily in an as-forged condition. Typically, the only gallery machining on the upper part is a local machining of the diameters of the inner and outer walls to better control their dimensions, and local machining of a region located above the upper ring grooves for reducing ring groove temperatures.

The pin bores are coaxially aligned along a pin bore axis A2. In the example embodiments, the pin bosses include a stepped cutout 80 on an upper side of the pin bores. The pin bores have an axial cross section which varies. In the example embodiment, the pin bosses include counter bores 82 at outermost edges of the pin bores to form the varying cross section. The stepped cutouts are designed to receive a bushing shell, and the counter bores are designed to receive pin caps. The pin caps can be press fit into the counter bores to retain the bushing shell, seal the pin bores, and prevent gasses from the intake and exhaust ports from leaking past the piston body into the crank case.

Another aspect of the invention provides a method of manufacturing the piston. The method includes providing the upper part and the lower part, and joining the lower part to the upper part. According to one embodiment, the method includes providing the lower part by casting 4140 steel, and providing the upper part by forging a steel material which is different from the 4140 steel of the lower part. According to another embodiment, both the upper part and the lower part are formed of the 4140 steel.

According to the preferred embodiment, the step of joining the upper part to the lower part includes hybrid induction welding the upper outer rib to the lower outer rib to form the outer joint therebetween and hybrid induction welding the upper inner rib to the lower inner rib to form the inner joint therebetween. The hybrid induction welding step includes heating the upper part and the lower part by induction, rotating the ribs of the upper part clockwise against ribs of the lower part after the heating step and rotating the ribs of the upper part counterclockwise against the ribs of the lower part after rotating the upper part clockwise, and applying a greater pressure to the upper and lower parts while rotating the upper part counter clockwise than while rotating the upper part clockwise. However, induction welding, resistance welding, charge carrier rays, electron beam welding, laser welding, stir welding, brazing, soldering, hot or cold diffusion, friction welding, or another bonding process could be used to join the parts.

Many modifications and variations of the present invention are possible in light of the above teachings and may be practiced otherwise than as specifically described while within the scope of the claims. It is also contemplated that all features of all claims and of all embodiments can be combined with each other, so long as such combinations would not contradict one another.

What is claimed is:

1. A piston comprising:
a body extending longitudinally along a center axis from an upper end to a lower end, said body including:
an upper wall at said upper end,
an outer wall and an inner wall each depending from said upper wall and extending circumferentially around said center axis,
a lower wall spaced axially from said upper wall by said outer and inner walls,
said upper and lower walls radially spacing said inner wall from said outer wall and presenting an outer cooling gallery therebetween,
a pair of skirt sections depending longitudinally from said outer wall,
a pair of pin bosses depending longitudinally from said outer wall and spacing said skirt sections from one another,
said lower wall including first portions extending radially inwardly from said outer wall to said inner wall above said skirt sections,
said lower wall including second portions extending radially inwardly from said outer wall to said inner wall above said pin bosses,
said first portions extending oblique to said center axis and said second portions extending perpendicular to said center axis,
said skirt sections having a radial thickness being greater in a lower portion of said skirt sections than an upper portion of said skirt sections, and
said lower portion of said skirt sections including a plurality of ring grooves for containing piston rings.

2. The piston of claim 1, wherein said first portions of said lower wall above said skirt sections present an angle of less than 90 degrees therebetween.

3. The piston of claim 1, wherein said first portions of said lower wall undulate between said outer wall and said inner wall.

4. The piston of claim 1, wherein said first portions and said second portions extend in an arcuate shape around said center axis.

5. The piston of claim 1, wherein said piston body includes an upper part welded to a lower part, said upper part includes said upper wall and an upper outer rib and an upper inner rib, said lower part includes said lower wall and a lower outer rib and a lower inner rib, said upper outer rib is joined to said lower outer rib at an outer joint to form said outer wall, and said upper inner rib is joined to said lower inner rib at an inner joint to form said inner wall.

6. The piston of claim 5, wherein said inner and outer joints include a hybrid induction weld.

7. The piston of claim 5, wherein said lower part is formed of 4140 steel and said upper part is formed of a steel material different from said 4140 steel of said lower part.

8. The piston of claim 1, wherein said upper wall includes a combustion surface presenting a combustion bowl, and said combustion bowl has an asymmetric shape.

9. The piston of claim 1, wherein said inner and outer walls extend parallel to said center axis.

10. The piston of claim 1, wherein said outer cooling gallery has an axial cross section which is asymmetric and is greater along said first portions of said lower wall than said second portions of said lower wall.

11. The piston of claim 1, wherein said inner wall and said upper wall and said lower wall present an inner cooling gallery therebetween, and said inner cooling gallery is sealed and contains air.

12. The piston of claim 1, wherein said pin bosses present pin bores coaxially aligned along a pin bore axis, and said pin bosses include a stepped cutout on an upper side of said pin bores, and said pin bores have an axial cross section which varies along said pin bore axis.

13. The piston of claim 1, wherein said lower portion of said skirt sections including said lower ring grooves is located axially below said pin bores.

14. The piston of claim 1, wherein said lower portion of said skirt sections includes apertures for allowing cooling oil to flow through, and said lower wall includes orifices to said outer cooling gallery for allowing cooling oil to flow through.

15. The piston of claim 1, wherein said piston body includes an upper part welded to a lower part,
said upper wall includes a combustion surface presenting a combustion bowl,
said combustion bowl has an asymmetric shape,
said upper part includes said upper wall and an upper outer rib and an upper inner rib,
said lower part is formed of 4140 steel and said upper part is formed of a steel material different from said 4140 steel of said lower part,
said lower part includes said lower wall and a lower outer rib and a lower inner rib,
said upper outer rib is welded to said lower outer rib at an outer joint to form said outer wall,
said upper inner rib is welded to said lower inner rib at an inner joint to form said inner wall,
said inner and outer walls extend parallel to said center axis,
said outer wall includes a plurality of upper ring grooves for containing piston rings,
said outer cooling gallery has an axial cross section which is asymmetric and is greater along said first portions of said lower wall than said second portions of said lower wall,
said first portions are spaced circumferentially from one another by said second portions,
said first portions of said lower wall above said skirt sections present an angle of less than 90 degrees therebetween,
said first portions of said lower wall undulate between said outer wall and said inner wall,
said first portions and said second portions extend in an arcuate shape around said center axis,
said outer wall and said inner wall extends circumferentially around said center axis,
said inner wall and said upper wall and said lower wall present an inner cooling gallery therebetween,
said inner cooling gallery is sealed and contains air,
said lower wall includes orifices to said outer cooling gallery for allowing cooling oil to flow through,
said pin bosses present pin bores coaxially aligned along a pin bore axis,
said pin bosses include a stepped cutout on an upper side of said pin bores,
said pin bores have an axial cross section which varies,
said pin bosses include counter bores at outermost edges of said pin bores,
said skirt sections are connected to said pin bosses by struts,
said lower portion of said skirt sections including said lower ring grooves is located axially below said pin bores, and
said lower portion of said skirt sections includes apertures for allowing cooling oil to flow through.

16. A method of manufacturing a piston comprising the steps of:
providing an upper part extending along a center axis, the upper part including an upper wall, an upper outer rib depending from the upper wall, and an upper inner rib depending from the upper wall; and
joining a lower part to the upper part, the lower part extending longitudinally along the center axis, the lower part including a lower wall, a lower outer rib extending upward from the lower wall, a lower inner rib extending upward from the upper wall, skirt sections depending longitudinally from the lower wall, pin bosses depending longitudinally from the lower wall and spacing the skirt sections from one another, the lower wall including first portions extending radially inwardly from the lower outer rib to the lower inner rib above the skirt sections, the lower wall including second portions extending radially inwardly from the lower outer rib to the lower inner rib above the pin bosses, the first portions extending oblique to the center axis and the second portions extending perpendicular to the center axis, the skirt sections including a radial thickness being greater in a lower portion of the skirt sections than an upper portion of the skirt sections, and the lower portion of the skirt sections including a plurality of ring grooves for containing piston rings.

17. The method of claim 16, wherein the step of joining the upper part to the lower part includes hybrid induction welding the upper outer rib to the lower outer rib to form an outer joint therebetween and hybrid induction welding the upper inner rib to the lower inner rib to form an inner joint therebetween, the hybrid induction welding step includes heating the upper part and the lower part by induction, the hybrid induction welding including rotating the upper part clockwise against the lower part after the heating step and rotating the upper part counterclockwise against the lower part after rotating the upper part clockwise, and applying a greater pressure to the upper and lower parts while rotating the upper part counter clockwise than while rotating the upper part clockwise.

18. The method of claim 16 including providing the lower part by casting 4140 steel.

19. The method of claim 18, wherein the step of providing the upper part includes forging a steel material which is different from the 4140 steel of the lower part.

20. The method of claim 16 including providing the lower part by casting 4140 steel,
wherein the step of providing the upper part includes forging a steel material which is different from the 4140 steel of the lower part,
the step of joining the upper part to the lower part includes hybrid induction welding the upper outer rib to the lower outer rib to form an outer joint therebetween and hybrid induction welding the upper inner rib to the lower inner rib to form an inner joint therebetween,
the hybrid induction welding step includes heating the upper part and the lower part by induction,
the hybrid induction welding includes rotating the upper part clockwise against the lower part after the heating step and rotating the upper part counterclockwise against the lower part after rotating the upper part clockwise, and
the hybrid induction welding includes applying a greater pressure to the upper and lower parts while rotating the upper part counter clockwise than while rotating the upper part clockwise.
